(19) United States
(12) Patent Application Publication
(10) Pub. No.: US 2015/0135510 A1
(43) Pub. Date: May 21, 2015

(54) LOCKING SYSTEM FOR A THREADED CONNECTION

(71) Applicant: Weatherford/Lamb, Inc., Houston, TX (US)

(72) Inventors: Manish AGARWAL, Cypress, TX (US); Michael JUENKE, Spring, TX (US)

(21) Appl. No.: 14/533,248

(22) Filed: Nov. 5, 2014

Related U.S. Application Data
(60) Provisional application No. 61/905,543, filed on Nov. 18, 2013.

(51) Int. Cl. F16B 39/10

(52) U.S. Cl. CPC F16B 39/10
USPC 29/456; 29/700; 29/235; 29/225

(57) ABSTRACT

A locking system for a connection between two parts, comprising a first part; a second part for connection with the first part; and an interfering member, the member constructed and arranged to permit connection and thereafter, to prevent separation of the parts.

### BACKGROUND OF THE INVENTION

1. Field of the Invention

Embodiments of the present invention generally relate to a connection system for a threaded connection. More particularly, the invention relates to a locking system for a threaded connection between two parts of a downhole apparatus.

2. Description of the Related Art

Threaded connections are used routinely to join two pieces of equipment together for use in a wellbore. In one example, a nose piece is fitted to a body or mandrel of a tool to facilitate the insertion of the tool into a wellbore. The connection is intended to be “permanent” with no need to separate the two pieces. In fact, separation of the pieces is to be avoided as the tool can malfunction or otherwise become inoperable due to separation of components in operation. Presently, various methods are used to prevent parts from becoming unthreaded in use. In one example, an aperture is drilled through the connection and a pin is inserted. Thereafter, the pin head is deformed to prevent the pin from backing out. In another example the threads are “locked” with cement. In yet another arrangement the threads are welded. These arrangements are time-consuming, unreliable and not uniform in their use.

What is needed is a more effective way of keeping threaded parts from becoming loose or disconnected in use.

### SUMMARY OF THE INVENTION

The present invention generally includes a locking system for a connection between two parts, comprising a first part; a second part for connection with the first part; and an interfering member, the member constructed and arranged to permit connection and thereafter, to prevent separation of the parts.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a partial section view of a male and female part prior to connection.

FIG. 2 is a partial section view of the parts during connection.

FIG. 3 is a partial section view of the parts threadedly connected together and locked together with a snap ring.

FIG. 4 is a partial section view showing another embodiment of the invention.

### DETAILED DESCRIPTION

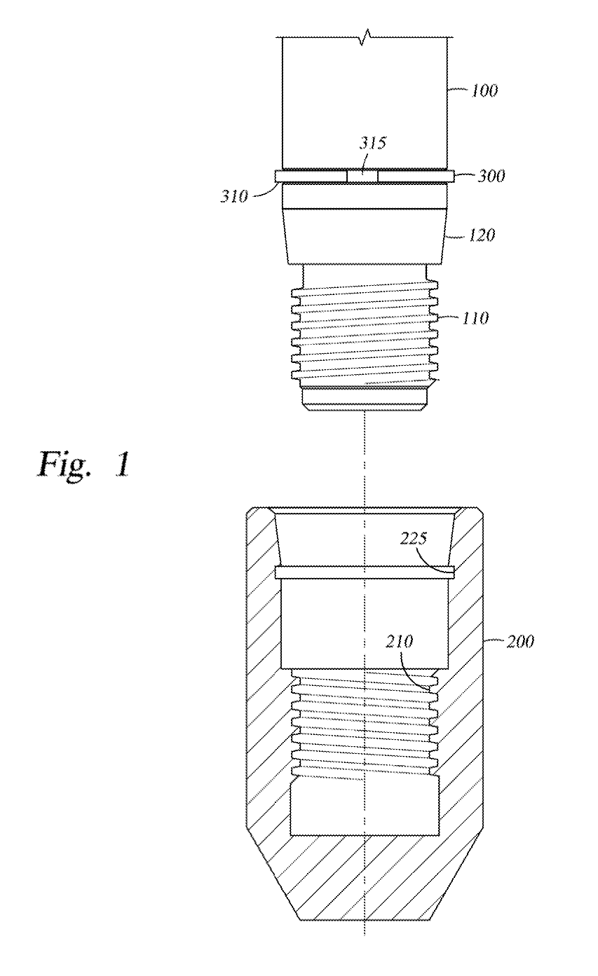

FIG. 1 is a partial section view of two parts 100, 200 to be mated together. A first part 100 includes a threaded portion 110 having male threads and a second part 200 has mating female threads 210. The threads in the embodiment shown are typical, and the first part includes a tapered nose portion 120 to facilitate the initial mating of the parts before the threads 110, 210 are engaged by relative rotation between the parts.

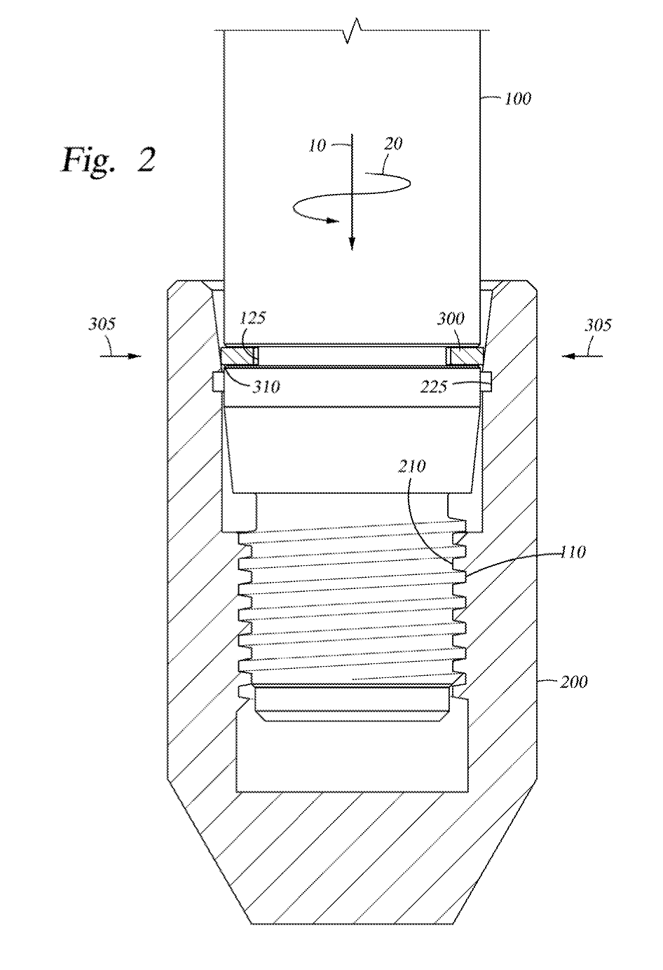

In addition to the male threads 110, the first part 100 includes a resilient member in form of a snap ring 300 disposed on its outer diameter in a groove 125 formed to house the ring (FIG. 2). The snap ring 300 and groove 125 are designed and chosen whereby the ring fits in the groove and an outer portion of the ring extends from the groove to form a shoulder 310, thereby increasing the outer diameter of the first component 100 in the area of the ring.

Snap rings or retaining rings are known in the art and are essentially a fastener for holding a second component on a first component, especially when installed in a groove. Once installed, the exposed portion acts as a shoulder which retains the second component, especially when the mating component has a matching groove to house the outer surface of the ring while the inner surface of the ring remains housed around the groove in the first component. Snap rings are typically made from carbon steel or stainless steel and may feature a variety of finishes for corrosion protection, depending on the type of environment in which they are used.

In installation, the snap ring is designed to be slid over the threads 110 and tapered portion 120 of the first part 100 until it reaches the groove 125. As the ring is passed onto the part, it expands due to a gap 315 provided in the body of the ring and then “snaps” into the groove 125.

FIG. 2 is a partial section view of the parts 100, 200 during connection. As shown by arrow 20, the first component is rotated via the threaded connection between the parts, and axial motion (arrow 10) is transmitted by the threads. In FIG. 2, the parts are partially threaded together to a point whereby the snap ring 300 and groove 125 of the first part is approaching a groove 225 formed in an inner diameter of the second part 200. As shown, a tapered opening 230 in the second part is compressing the ring 300 (arrows 305), thereby reducing its circumference by reducing the size of gap 315. The connection is constructed and arranged whereby the snap ring 300 axially fixes the two parts 100, 200 together at a point wherein the threaded connection is essentially complete. The space between the ring 300 and the groove 225 of the second part and between the end of the male threads 110 and the female threads 210 illustrate the connection is not yet completed.

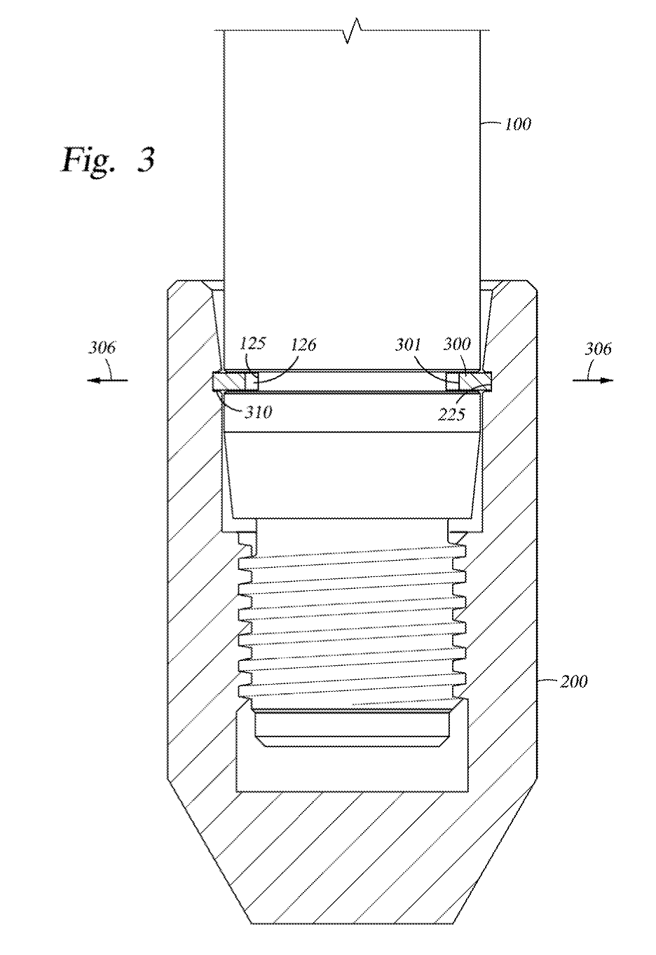

In FIG. 3 the threaded connection is completed, and the snap ring 300 has met and expanded (arrows 306) into the groove 225 formed in an inside diameter of the second part 200. As shown, a space 126 now exists between the inside diameter 301 of the expanded snap ring 300 and an outer surface groove 125.

In one embodiment, the locking system is utilized in the following manner: A resilient member 300 is installed on a first part 100 of a component for use downhole. Installation is complete when the resilient member is housed in a preformed groove 125 formed in an outer diameter of the first part 100. Thereafter, the first and second portions are threaded together using mating threads formed on each. At a point when the threaded connection is made, the resilient member, whose diameter is decreased as the first portion moves into the second portion, finds and snaps into a mating groove 225 formed on the inside surface of the second part 200. Once the ring is retained in the grooves 125, 225 a slight amount of rotation might be possible between the parts 100, 200 but not enough to permit axial movement therebetween.

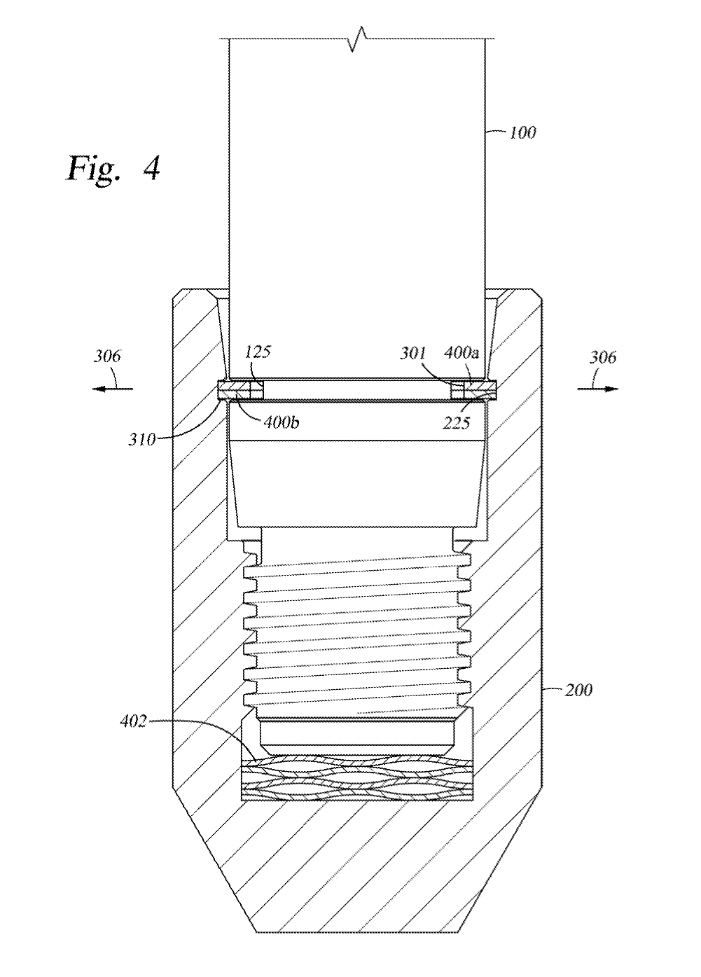

FIG. 4 is a partial section view showing another embodiment of the invention. As with the previous embodiment, a first 100 and second 200 parts are joined together with male and female threads. There is also a groove 125 in the first part for initially housing the ring and a mating groove 225 in the second part to receive the ring as the threading of the parts is completed. However, unlike the previous embodiment, two rings 400a, 400b are provided, each typically having the same dimensions and thickness. While each ring includes a gap 315 (not shown) the gaps of each ring need not be rotationally aligned. In the embodiment shown, the rings are about ½ the thickness of the rings used in the previous embodiment meaning that the grooves into which they fit are the same width and depth in both examples. Utilizing two rings rather than one provides some redundancy in case one ring fails during assembly.

In addition to an additional ring, the embodiment of FIG. 4 includes a resilient member like spring that is placed in the inner end of the second part in a manner that causes it to be compressed as the connection is made. Preloading devices like springs are well known for preventing threaded connections from “backing off” after the connection is made.

In each of the forging examples, interference created between the ring or rings and the grooves of parts 100, 200, the threaded connection and any resilient member the connection is essentially locked with little or no axial or rotational movement possible between the parts. Because the locking structure is internal to the connection, it is protected from damage as the downhole component is run in and removed from the wellbore and, in the case of a plunger for a downhole pump, as it reciprocates up and down in the well.

While the foregoing is directed to embodiments of the present invention, other and further embodiments of the invention may be devised without departing from the basic scope thereof, and the scope thereof is determined by the claims that follow. For example, any number of rings can be used and the grooves and resilient members need not be strictly circumferential so long as there is an interference between the parts preventing their rotation due to a third member internally housed in the connection between the parts when they are threaded together.

1. A locking system for a connection between two parts, comprising:
a first part;
a second part for connection with the first part; and
an interfering member, the member constructed and arranged to permit connection and thereafter, to prevent separation of the parts.

2. The system of claim 1, wherein the interfering member is a resilient member.

3. The system of claim 2, wherein the first part has male threads and the second part has female threads and the connection is a threaded connection.

4. The system of claim 3, wherein the resilient member is a compressible snap ring having a variable circumference.

5. The system of claim 4, wherein, prior to the connection being made, the snap ring is at least partially housed in an outer surface of the first part.

6. The system of claim 5, wherein the snap ring is at least partially housed in a groove formed in the outer surface.

7. The system of claim 6, wherein when the threaded connection is made, the snap ring is partially housed in the groove in the outer surface and partially housed in a grooved formed in an inner surface of the second part.

8. The system of claim 7, wherein when the threaded connection is made, interference between parts and the snap ring prevents axial movement of one part relative to the other part.

9. The system of claim 8, wherein the inner surface of the second part includes a tapered surface constructed and arranged to reduce the circumference of the snap ring as the parts are threaded together.

10. The system of claim 9, further including a second snap ring adjacent the snap ring wherein both snap rings are housed in the grooves.

11. The system of claim 9, further including a preloading member installed between the first and second parts for placing a preload on the threaded connection after the connection is made.

12. The system of claim 11, wherein the preload member is a spring located in a distal end of the second part, the spring compressible by the first part when the connection is made.

13. A method of locking two parts together, comprising:
providing a first part having male threads, a second part having female threads, a snap ring housed in a groove on the outer surface of the first part and a groove formed on an inner surface of the second part;
connecting the parts together by threading; and
locking the parts together by causing the snap ring to be housed in both grooves, thereby creating interference between the threaded members.
